(19) United States
(12) Patent Application Publication
(10) Pub. No.: US 2005/0011023 A1
(43) Pub. Date: Jan. 20, 2005

(54) Electric toothbrush

(76) Inventor: Kwok Sing Chan, Hong Kong (CN)

Correspondence Address: ALIX YALE & RISTAS LLP, 750 MAIN STREET, SUITE 1400, HARTFORD, CT, 06103, US

(21) Appl. No.: 10/622,062

(22) Filed: Jul. 17, 2003

(51) Int. Cl. A61C 17/22

(52) U.S. Cl. 15/22.1; 15/28

(57) ABSTRACT

A brushing attachment for an electric toothbrush includes an elongate neck, a head at an end of the neck, a tuft block located at the head and having bristles parallel to an axis extending in a direction substantially normal to the neck. The tuft block is mounted to the head so as to be movable linearly along the axis and pivotally about the axis. There is a recess in the tuft block facing toward the neck. A driveshaft extends through the neck and has and angularly offset arm received within the recess to effect movement of the tuft block.

### BACKGROUND OF THE INVENTION

The present invention relates to electric toothbrushes. More particularly, although not exclusively, the invention relates to an electric toothbrush head having a tuft block that oscillates pivotally as well as up and down in use.

Many electric toothbrushes have been proposed with rotating or pivotally oscillating bristle heads. Many of these suffer from complexity of design, cleaning-inefficiency and general inefficiency in operation.

### OBJECTS OF THE INVENTION

It is an object of the present invention to overcome or substantially ameliorate at least one of the above disadvantages and/or more generally to provide an improved electric toothbrush.

### DISCLOSURE OF THE INVENTION

There is disclosed herein a brushing attachment for an electric toothbrush, comprising:
an elongate neck,
a head at an end of the neck,
a tuft block located at the head and having bristles parallel to an axis extending in a direction substantially normal to the neck, the tuft block being mounted to the head so as to be movable linearly along the axis and pivotally about the axis, the tuft block having a recess therein facing toward the neck, and
a driveshaft extending through the neck and having and angularly offset arm received within the recess.

Preferably the head comprises a fixed pin on which the tuft block is mounted.

Preferably the driveshaft comprises a dogleg from which the angularly offset arm extends from a radially outer position toward a longitudinal axis of the driveshaft.

Preferably the recess in the tuft block comprises a slot extending in a direction parallel to the axis and a blind hole opening to the slot, and the angularly offset arm comprises an intermediate bearing engaging with the slot to effect pivotal movement of the tuft block, and a remote bearing engaging with the blind hole to effect linear oscillation of tuft block.

The above-disclosed attachment might be attached to or formed integrally with an electric toothbrush.

### BRIEF DESCRIPTION OF THE DRAWINGS

A preferred form of the present invention will now be described by way of example with reference to the accompanying drawings, wherein:

FIG. 1 is a schematic perspective illustration of a brushing attachment for an electric toothbrush,

FIG. 2 is a schematic cross-sectional elevational view of the brushing attachment of FIG. 1 showing the tuft block in a lowered position,

FIG. 3 is a schematic cross-sectional elevational view of the brushing attachment of FIG. 1 showing the tuft block in a raised position,

FIG. 4 is a schematic plan view of the brushing attachment of FIG. 1,

FIG. 5 is a schematic cross-sectional plan view of the brushing attachment of FIG. 1, showing the tuft block at one extreme pivotal orientation,

FIG. 6 is a schematic plan view of the brushing attachment of FIG. 1, showing the tuft block at an opposite extreme pivotal orientation,

FIG. 7 is an inverted plan view of the tuft block,

FIG. 8 is a schematic cross-sectional elevational view of the tuft block, and

FIG. 9 is a schematic end elevational view of the tuft block.

### DESCRIPTION OF THE PREFERRED EMBODIMENT

In the accompanying drawings there is depicted schematically a brushing attachment 10 for an electric toothbrush. The depicted components are typically fabricated as plastics mouldings.

The attachment 10 includes a neck 11 having a driveshaft 15 passing therethrough. At the end of the neck 11, there is a head 12 to which a tuft block 13 having bristles 14 is mounted.

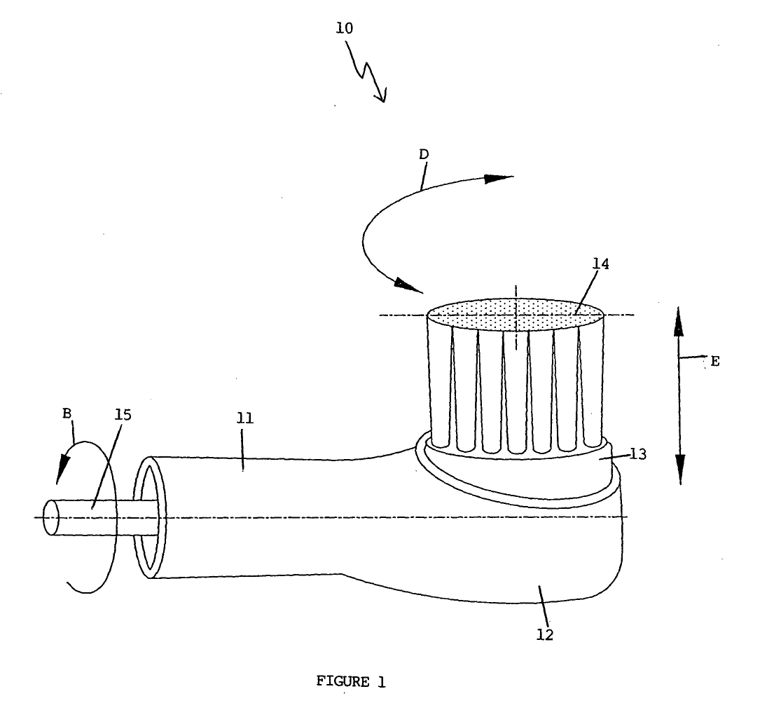

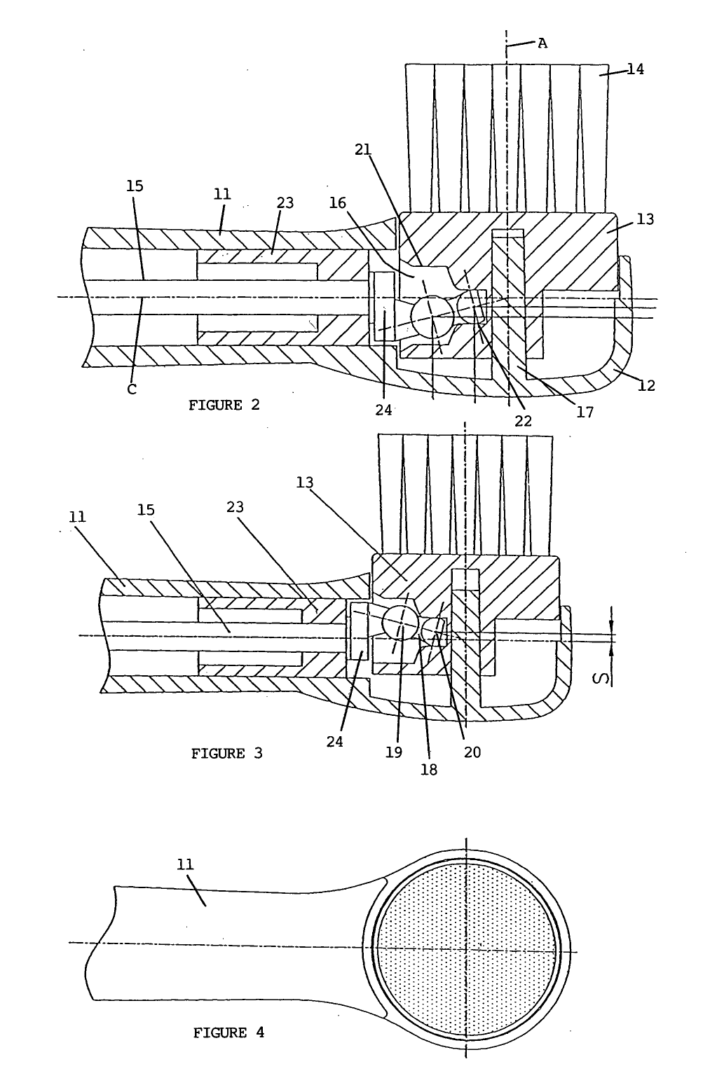

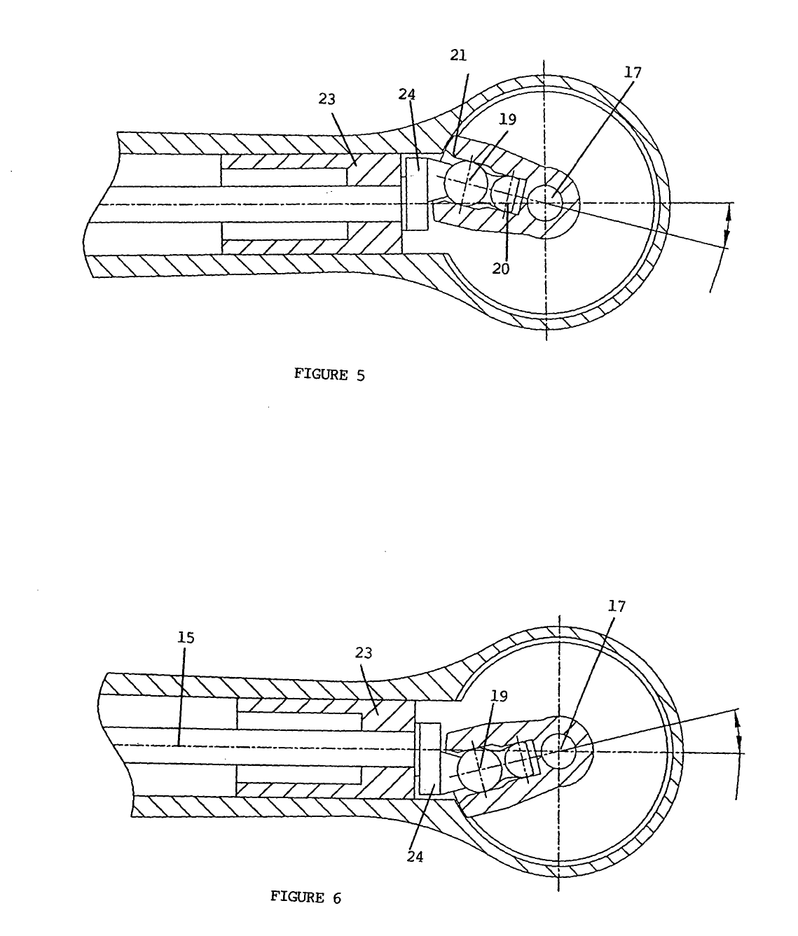

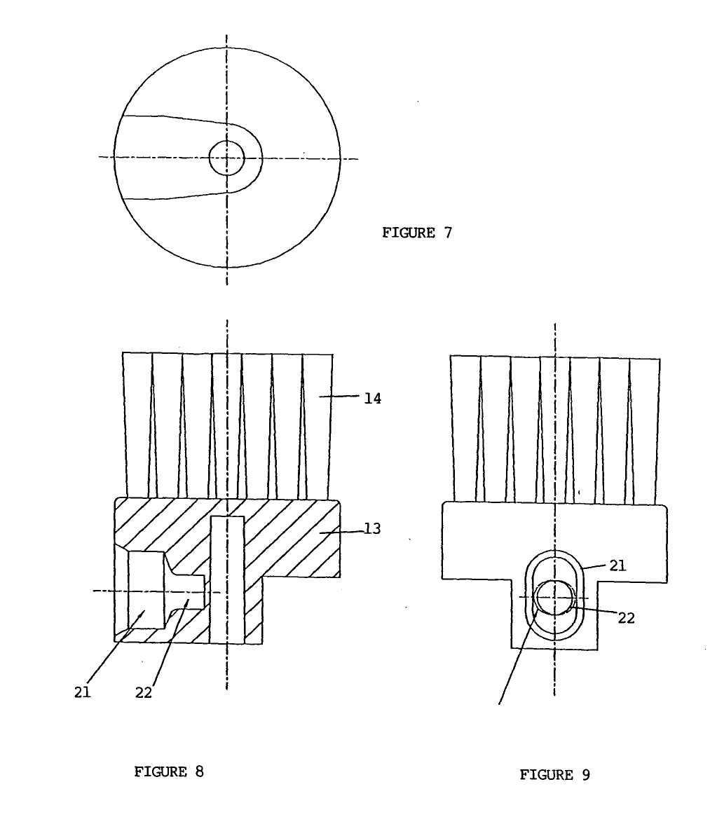

Within the head 12, there is a fixed pin 17 over which the tuft block 13 is fitted so as to be pivotable about an axis A that extends normally to the longitudinal extent of the neck 11. The driveshaft 15 is driven to rotate as indicated by arrow B in FIG. 1 and is mounted within a sleeve 23. The driveshaft 15 has a dogleg 24 from which an angularly offset arm 18 extends. The arm 18 extends from a radially offset position of the dogleg 24 toward the longitudinal axis C of the driveshaft. There is an intermediate bearing 19 of substantially spherical form formed integrally with the arm 18. There is also a remote bearing 20 at the distal end of the arm 18.

The tuft block 13 has a recess 16 comprising a slot 21 and a blind hole 22. The intermediate bearing 19 bears against internal sidewalls of the opening slot 21, whereas the remote bearing 20 bears against an internal cylindrical surface of the blind hole 22.

Upon rotation of the driveshaft 15 the intermediate bearing 19 causes pivotal movement of the tuft block 13 and bristles 14 as indicated by the double-ended arrow D in FIG. 1. Also, action of the remote bearing 20 causes vertical reciprocation of the tuft block 13 and bristles 14 as indicated by the double-ended arrow E in FIG. 1.

The brushing attachment 10 would typically be a disposable unit attached to a handle of the electric toothbrush within which a motor and output sprocket would be situated. The driveshaft 15 would have means (not illustrated) for mechanically coupling to the output sprocket.

It should be appreciated that modifications and alterations obvious to those skilled in the art are not to be considered as beyond the scope of the present invention. For example, the driveshaft might be adapted for oscillatory motion, rather than continuously rotation.

1. A brushing attachment for an electric toothbrush, comprising:
an elongate neck,
a head at an end of the neck,
a tuft block located at the head and having bristles parallel to an axis extending in a direction substantially normal to the neck, the tuft block being mounted to the head so as to be movable linearly along the axis and pivotally about the axis, the tuft block having a recess therein facing toward the neck, and
a driveshaft extending through the neck and having and angularly offset arm received within the recess.

2. The attachment of claim 1, wherein the head comprises a fixed pin on which the tuft block is mounted.

3. The attachment of claim 1 wherein the driveshaft comprises a dogleg from which the angularly offset arm extends from a radially outer position toward a longitudinal axis of the driveshaft.

4. The attachment of claim 3 wherein the recess in the tuft block comprises a slot extending in a direction parallel to the axis and a blind hole opening to the slot, and the angularly offset arm comprises an intermediate bearing engaging with the slot to effect pivotal movement of the tuft block, and a remote bearing engaging with the blind hole to effect linear oscillation of tuft block.

5. An electric toothbrush having attached thereto or formed integrally therewith the brushing attachment of any one of the preceding claims.
